(19) United States
(12) Patent Application Publication
(10) Pub. No.: US 2025/0377487 A1
(43) Pub. Date: Dec. 11, 2025

(54) A MULTI-MATERIAL GRADIENT INDEX OPTIC, AND METHODS AND SYSTEMS OF USING

(71) Applicant: UNIVERSITY OF ROCHESTER, ROCHESTER, NY (US)

(72) Inventors: Ankur Xavier DESAI, Rome, NY (US); Greg R. SCHMIDT, Rochester, NY (US); Duncan T. MOORE, Fairport, NY (US)

(21) Appl. No.: 18/877,308

(22) PCT Filed: Jun. 26, 2023
(86) PCT No.: PCT/US2023/069075

§ 371 Date: Dec. 20, 2024

Related U.S. Application Data
(60) Provisional application No. 63/367,273, filed on Jun. 29, 2022.

(51) Int. Cl. G02B 3/00; G01J 3/02; G02B 1/00

(52) U.S. Cl. CPC G02B 3/0087; G01J 3/0208; G02B 1/00

(57) ABSTRACT

A hyperspectral imager using a freeform gradient-index lens using a GRIN comprised of three or more materials to disperse electromagnetic radiation comprising optical wavelengths. An achromatic lens comprising a multi-material gradient index profile formed by fabricating in a composition together four or more materials selected based on their individual refractive index, Abbe number and partial dispersion values. A dispersion controlling element used to separate electromagnetic radiation comprising optical wavelengths through use of a hyperapochromatic multi-material GRIN lens using a GRIN comprised of four or more materials.

This application claims priority to U.S. Provisional Patent Application No. 63/367,273, filed Jun. 29, 2022. The entirety of all of the aforementioned applications in incorporated herein by reference.

### FIELD

This application relates generally to chromatic dispersion and refraction in optical imaging, and in particular, the field of spectrometry and control and improvement of chromatic performance.

### BACKGROUND

A technique for improving a lens system is the use of gradient-index (GRIN) optics. All other variables being equivalent, a system with GRIN outperforms a homogeneous system across numerous categories. One such category is chromatic performance. Due to its unique dispersion properties, GRIN optics afford additional levels of color correction not achievable by homogeneous lenses. However, traditional technologies are limited to two material gradients, and are limited in spatial dimension control.

Color dispersion is also relevant in spectral splitting, which is a technique used to separate polychromatic light into its individual wavelengths or colors. One of the most well-known instances of this technique was when Sir Isaac Newton used a prism to show that white light was composed of many wavelengths from sunlight. Newton's simple prism would later form the backbone of many spectrometers-devices designed specifically to separate and measure the spectral components of light.

There still remains a need for improved optical performance for purposes of both achromatic lens design and spectral splitting. This need is addressed herein.

### SUMMARY

An aspect of this application is an imaging apparatus comprising: an optical system comprising at least one dispersion controlling element, wherein electromagnetic radiation is passed through said at least one dispersion controlling element, wherein said electromagnetic radiation comprises optical wavelengths; said at least one dispersion controlling element, wherein said dispersion controlling element is a multi-material gradient-index (GRIN) element, wherein the multi-material gradient-index element comprises three or more materials; said optical system also being capable of imaging said electromagnetic radiation onto at least one detecting element; said at least one detecting element being capable of detecting electromagnetic radiation passed through said dispersion controlling element.

Another aspect of the application is a method of using the imaging apparatus described herein, comprising the steps of: obtaining an image for use in one or more fields selected from the group consisting of agriculture, biotechnology, food analysis, environmental monitoring, medical imaging, artwork authentication, telecommunications, photonics, remote sensing and machine vision.

A further aspect of the application is a hyperspectral imaging method, comprising the steps of: fabricating in a composition together three or more different materials to form a dispersive element, wherein said formed dispersive element comprises a multi-material gradient-index profile; passing electromagnetic radiation through said dispersive element, wherein said electromagnetic radiation comprises optical wavelengths, wherein said passage through said dispersive element spectrally splits said optical wavelengths; detecting dispersed electromagnetic radiation from said dispersive element to form an image.

An aspect of the application is a multi-material gradient-index lens, comprising: four or more different materials, wherein said lens comprises a multi-material gradient-index profile.

An additional aspect of the application is a photonic integrated circuit comprising the multi-material gradient-index lens described herein.

Another aspect of the application is a system comprising the multi-material gradient-index lens described herein, wherein said lens is a sole dispersion controlling element within said system.

Another aspect of the application is a system comprising the multi-material gradient-index lens described herein, wherein said system comprises a plurality of dispersion controlling elements, and wherein said lens is placed in alignment with said plurality of dispersion controlling elements so that optical wavelengths passing through said plurality of dispersion controlling elements also passes through said lens.

An aspect of the application is a multi-material gradient index element, comprising: four or more different materials, wherein said lens comprises a multi-material gradient-index profile.

An additional aspect of the application is a photonic integrated circuit (PIC) comprising the multi-material gradient-index element described herein; the present application encompasses all instances where the GRIN technology herein is used in/on a PIC, i.e., it is one or more of the many elements used in a PIC.

Another aspect of the application is a system comprising the multi-material gradient-index element described herein, wherein said lens is a sole dispersion controlling element within said system.

Another aspect of the application is a system comprising the multi-material gradient-index element described herein, wherein said system comprises a plurality of dispersion controlling elements, and wherein said lens is placed in alignment with said plurality of dispersion controlling elements so that optical wavelengths passing through said plurality of dispersion controlling elements also passes through said lens.

Another aspect of the application is a method of using the multi-material gradient-index element described herein, comprising the steps of: placing said element so that light passes through said element; using said element in one or more fields selected from the group consisting of agriculture, biotechnology, food analysis, environmental monitoring, medical imaging, artwork authentication, telecommunications, photonics, remote sensing, illumination, lightguides and machine vision

### BRIEF DESCRIPTION OF THE DRAWINGS

FIG. 1 shows a homogeneous prism (left) versus a freeform gradient-index spectrometer (right).

FIG. 2 shows an example of a freeform gradient-index hyperspectral imager.

FIG. 3 shows the types of aberrations that spectrometers suffer from.

FIG. 4 shows an example of conventional color separation (left) and unconventional color separation (right). The unconventional color separation can be achieved by a single F-GRIN spectrometer with planar surfaces.

FIG. 5 shows achievable index, Abbe number, and partial dispersion values for a binary (5A), ternary 5B), and quaternary (5C) GRIN. These plots correspond to the materials used in the design studies discussed herein.

FIG. 6A shows a homogeneous singlet. FIG. 6B shows transverse ray error plot (right), scale of 50 microns. Average RMS wavefront performance is 1.31 wvs at 587.6 nm.

FIG. 7 shows a binary GRIN singlet (left). Δn_{d}=0.123. Transverse ray error plot (right), scale of 25 microns. Average RMS wavefront performance is 0.744 wvs at 587.6 nm. The material space for this design is outlined in FIG. 5A.

FIG. 8 shows a ternary GRIN singlet (left). Δn_{d}=0.026. Transverse ray error plot (right), scale of 1 micron. Average RMS wavefront performance is 0.026 wvs at 587.6 nm. The material space for this design is outlined in FIG. 5B.

FIG. 9A shows the composition ratios, γᵢ, of the three materials used in the ternary GRIN of FIG. 8. FIG. 9B shows a 2D cut-through of the composition of each of the three materials.

FIG. 10 shows a quaternary GRIN singlet (left). Δn_{d}=0.0447. Transverse ray error plot (right), scale of 1 micron. Average RMS wavefront performance is 0.014 wvs at 587.6 nm. The material space for this design is outlined in FIG. 5C.

FIG. 11A shows the composition ratios, γᵢ, of the four materials used in the quaternary GRIN of FIG. 10. The minimum value of γ₄ is 0.051. FIG. 11B shows a 2D cut-through of the composition of each of the four materials.

FIG. 12 shows a binary F-GRIN spectrometer (left). Δn=0.067. The spot diagram (right), shows unresolved and unseparated spots, indicating that the device is unusable. The average RMS wavefront performance across the spectrum is 2.29 wvs.

FIG. 13 shows a ternary F-GRIN spectrometer (left). Δn=0.021. The spot diagram (right), shows resolved and separated spots. The diffraction limited Airy disk is drawn in black over the central spot. The average RMS wavefront performance across the spectrum is 0.51 wvs. The average linearity error is 19.6 microns.

FIG. 14 shows a quaternary F-GRIN spectrometer (left). Δn=0.021. The spot diagram (right), shows resolved and separated spots. The diffraction limited Airy disk is drawn in black over the central spot. The average RMS wavefront performance across the spectrum is 0.47 wvs. The average linearity error is 11.8 microns.

FIG. 15 shows a second example of quaternary F-GRIN spectrometer using a different set of materials (left). Δn=0.021. The spot diagram (right), shows resolved and separated spots. The average RMS wavefront performance across the spectrum is 0.01 wvs, which is diffraction limited by the Marechal criterion. The average linearity error is 23.0 microns.

FIG. 16 shows a third example of high performing quaternary F-GRIN spectrometer using ideal materials (left). Δn=0.021. The spot diagram (right), shows resolved and separated spots. The average RMS wavefront performance across the spectrum is 0.01 wvs, which is diffraction limited according to the Marechal criterion. The average linearity error is 1.43 microns.

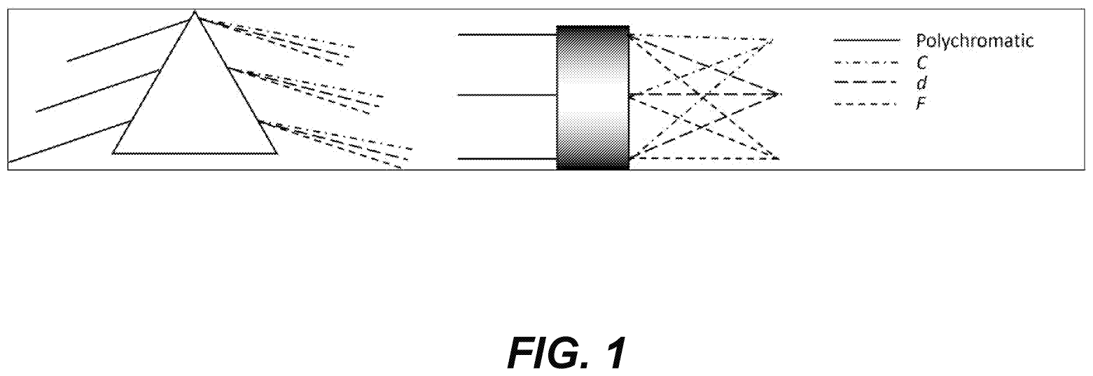

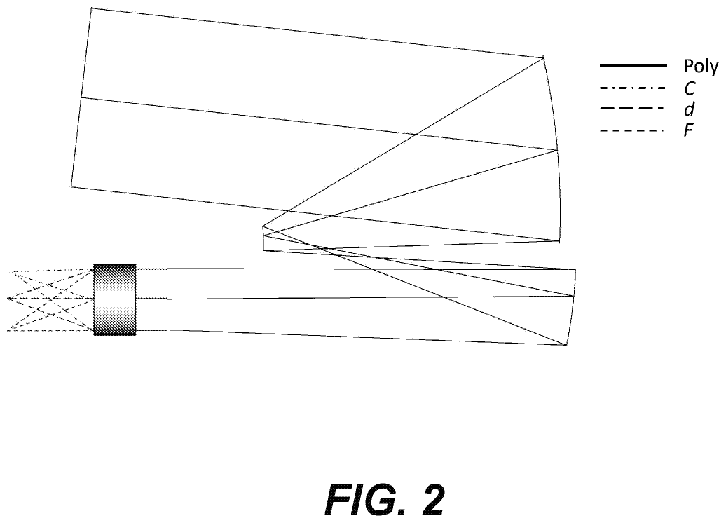

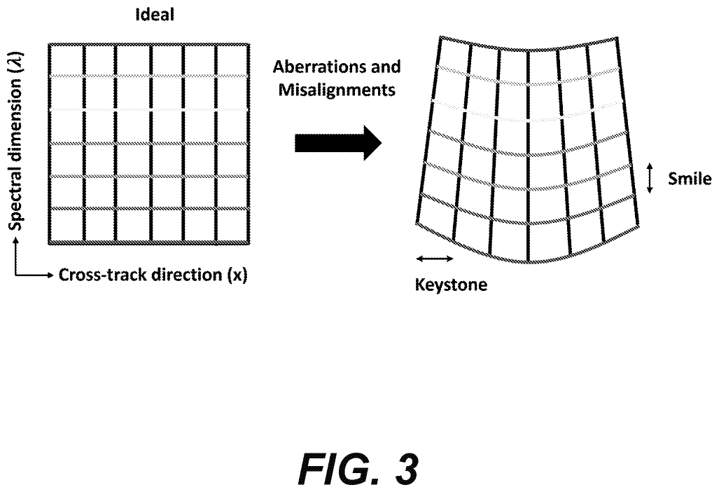

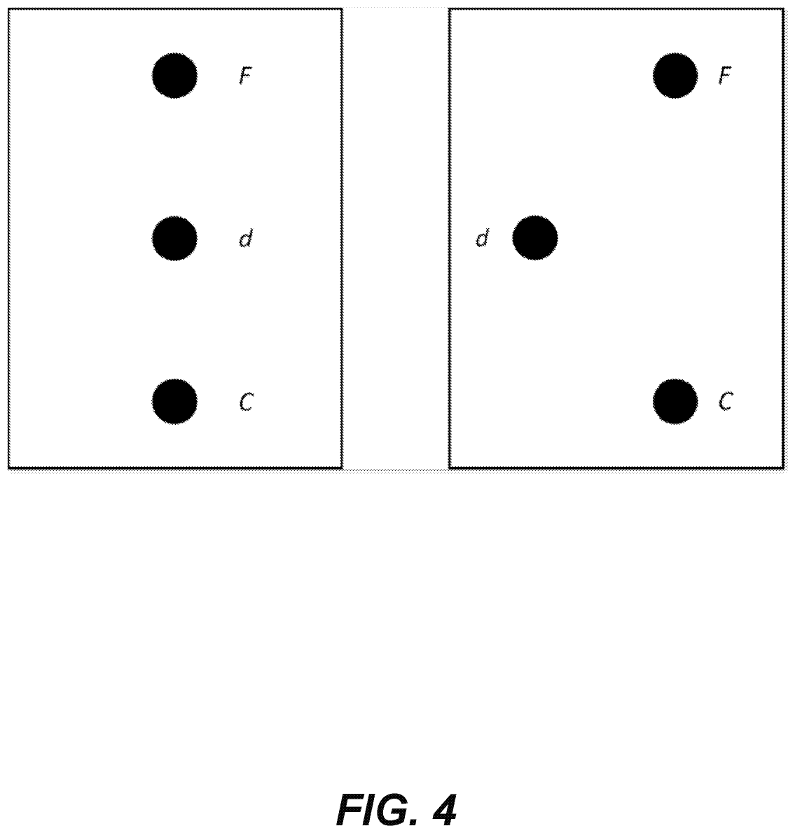

### DETAILED DESCRIPTION

Reference will be made in detail to certain aspects and exemplary embodiments of the application, illustrating examples in the accompanying structures and figures. The aspects of the application will be described in conjunction with the exemplary embodiments, including methods, materials and examples, such description is non-limiting and the scope of the application is intended to encompass all equivalents, alternatives, and modifications, either generally known, or incorporated here. Unless otherwise defined, all technical and scientific terms used herein have the same meaning as commonly understood by one of ordinary skill in the art to which this application belongs. One of skill in the art will recognize many techniques and materials similar or equivalent to those described here, which could be used in the practice of the aspects and embodiments of the present application. The described aspects and embodiments of the application are not limited to the methods and materials described.

As used in this specification and the accompanying claims, the singular forms “a,” “an” and “the” include plural referents unless the content clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to “the value,” greater than or equal to the value” and possible ranges between values are also disclosed, as appropriately understood by the skilled artisan. For example, if the value “10” is disclosed the “less than or equal to 10” as well as “greater than or equal to 10” is also disclosed.

The term “multi-material” herein refers to the use of a plurality of materials in optical elements that are fabricated compositions of three or more materials; where the three or more materials are fabricated as a composition together to form a gradient-index profile (including, without limitation, processes for fabrication such as various glass forming systems, ion exchange, the sol-gel process, 3D printed gradient-index glass optics (see, e.g., Dylla-Spears et al., Science Advances 18 Nov. 2020 Vol 6, Issue 47), polymer processes, etc); and where the materials have been selected on the basis of their individual refractive index, Abbe number, and partial dispersion values. One of ordinary skill will understand that the use of a multi-material gradient-index profile for the purposes as described herein is not limited by use of techniques such as additive manufacturing or mixed molten salt baths to produce the multi-material gradient-index profile. One of ordinary skill will understand that the term “multi-material” is not limited to a particular upper ceiling number of materials being used; rather the needs of the optical designer will influence the particular choice of the number or type of materials used in a multi-material gradient-index profile for the purposes described herein. In certain embodiments, materials are selected based on their wavelength dependent optical properties. In certain embodiments, a multi-material may be selected based on thermal properties.

In certain embodiments, the multi-material gradient-index profile is produced by processes of fabrication such as layering, (e.g., Boyd et al., Layered polymer GRIN lenses and their benefits to optical designs, Advanced Optical Technologies, De Gruyter, Sep. 8, 2015), or frits, to manufacture compositions of three or more materials that have been selected on the basis of their individual refractive index, Abbe number, and partial dispersion values.

In certain preferred embodiments, the term “multi-material” may refer to four or more materials fabricated as a composition together to form a gradient-index profile as described herein, where the materials have been selected on the basis of their individual refractive index, Abbe number, and partial dispersion values.

In a particular embodiment, the term “multi-material” refers to the use of three or more materials fabricated in a composition together to form a gradient-index profile, where the materials have been selected on the basis of their individual refractive index, Abbe number, and partial dispersion values, in a solid dispersion controlling element in a spectrometer as described herein. In a particular embodiment, the term “multi-material” refers to the use of four or more materials fabricated in a composition together to form a gradient-index profile, where the materials have been selected on the basis of their individual refractive index, Abbe number, and partial dispersion values, in a lens as described herein.

The term “freeform” herein refers to any GRIN medium that must be specified in two or more independent spatial coordinates; and thus, is a freeform GRIN (F-GRIN) (see David H. Lippman, Nicholas S. Kochan, Tianyi Yang, Greg R. Schmidt, Julie L. Bentley, and Duncan T. Moore, “Freeform gradient-index media: a new frontier in freeform optics,” Opt. Express 29, 36997-37012 (2021)).

The term “optical wavelengths” used herein refers to electromagnetic radiation forming an electromagnetic wave (see, e.g., Gregory E. Stillman, in Reference Data for Engineers (Ninth Edition) 2002 (“The optical spectrum is generally defined to encompass electromagnetic radiation with wavelengths in the range from 10 nm to 10³ μm, or frequencies in the range from 300 GHz to 3000 THz”)). The waves at different lengths contribute to the radiation spectrum and the separated wavelengths form a range. In other words, the wavelength is a distance between two recurring wave elements (see, e.g., Eugene Hecht, Optics, Addison-Wesley, 2002; Max Born and Emil Wolf, Principles of Optics, 1990).

Optical wavelengths may be classified as infra-red (780 nm-1 mm), visible (380 nm-780 nm) and ultraviolet (100 nm-380 nm). In certain embodiments, optical wavelengths are in the range between 10 nm to 1000 micrometers.

Optical wavelengths include electromagnetic radiation in the wavelength range which can be perceived by the human eye known as “visible wavelengths.” In certain embodiments herein, the visible electromagnetic radiation has a wavelength between 369 nm to 830 nm; in other embodiments, the visible electromagnetic radiation has a wavelength between 486.1 nm to 656.3 nm.

The term “superapochromatic” herein means when a lens or system of lenses is color corrected at four wavelengths [Zhang, Y. & Gross, H. (2019). Systematic design of microscope objectives. Part I: System review and analysis. Advanced Optical Technologies, 8(5), 313-347].

The term “hyperapochromatic” herein means when a lens or system of lenses is color corrected at five or more wavelengths.

The term “photonic integrated circuit” herein means a photonic integrated circuit (PIC) or integrated optical circuit which is a microchip containing two or more photonic components which form a functioning circuit. This technology detects, generates, transports, and processes light. Photonic integrated circuits utilize photons (or particles of light). A photonic integrated circuit provides functions for information signals imposed on optical wavelengths typically in the visible spectrum or near infrared (850-1650 nm) (though not necessarily limited thereto).

One of ordinary skill will understand that the methods, systems, apparatus, devices and elements described herein may be using for both imaging and non-imaging applications.

An aspect of the application is a new class of spectrometers that leverage the unique chromatic properties of gradient-index (GRIN) materials to achieve the spectral splitting [Tianyi Yang, David H. Lippman, Robert Y. Chou, Nicholas S. Kochan, Ankur X. Desai, Greg R. Schmidt, Julie L. Bentley, Duncan T. Moore, “Material optimization in the design of broadband gradient-index optics,” Proc. SPIE 12078, International Optical Design Conference 2021, 120780Z (19 Nov. 2021)]. It is shown that a traditional binary GRIN lacks the dispersion characteristics necessary to both separate the colors and achromatically focus the light. A ternary GRIN is the simplest case that can theoretically accomplish both tasks. Adding more materials, such as a quaternary GRIN, provides additional and unexpected improvements in control of chromatic performance, and also in applications such as spectrometry.

In particular, this application is the first implementation of a multi-material GRIN spectrometer of any kind.

A GRIN singlet can be used to correct primary chromatic aberrations, analogous to a homogeneous cemented doublet [John P. Bowen, J. Brian Caldwell, Leo R. Gardner, Niels Haun, Michael T. Houk, Douglas S. Kindred, Duncan T. Moore, Masataka Shiba, and David Y. H. Wang, “Radial gradient-index eyepiece design,” Appl. Opt. 27, 3170-3176 (1988); P. J. Sands, “Inhomogeneous Lenses, II. Chromatic Paraxial Aberrations,” Vol. 61, Issue 6, pp. 777-783 (1971)]. In a cemented doublet, the dispersion of the two materials and powers of the two elements balance one another,

$$\frac{{Φ}_{1}}{{V}_{1}} + \frac{{Φ}_{2}}{{V}_{2}} = 0 \qquad ( 1 )$$

where Φᵢ and Vᵢ are the power and Abbe numbers of the i^{th} element. The Abbe number is defined as

$$V = \frac{{n}_{mid} - 1}{{n}_{short} - {n}_{long}} \qquad ( 2 )$$

where n is the refractive index; the Abbe number describes how dispersive a material is. In a GRIN singlet, the aberrations from the surfaces and the GRIN contribution balance, providing an achromatic focus.

### Visualizing the Three-Dimensional Material Space

Designing achromatic doublets and apochromatic triplets often involves heavy use of glass charts. These 2D charts plot a material's refractive index versus Abbe number and a material's Abbe number versus partial dispersion, which for the purposes of this application is defined as

$$P = \frac{{n}_{short} - {n}_{mid}}{{n}_{short} - {n}_{long}}$$

which is rendered in this specific instance below as:

$${P}_{F , d} = \frac{{n}_{F} - {n}_{d}}{{n}_{F} - {n}_{C}}$$

where n_{F}, n_{d}, and n_{C} are the refractive indices at short (F), middle (d) and long (c) wavelengths, respectively. The partial dispersion is the departure from a linear relation between wavelength and refractive index curve. Knowing where the materials sit in this space is crucial to achieving high levels of color correction.

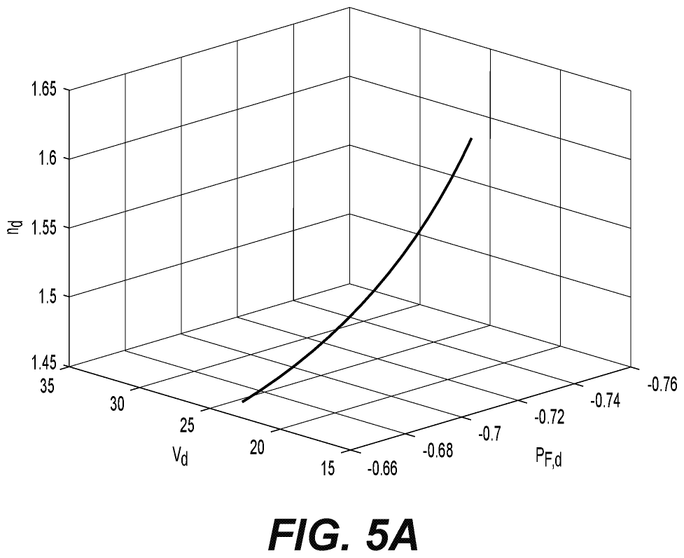

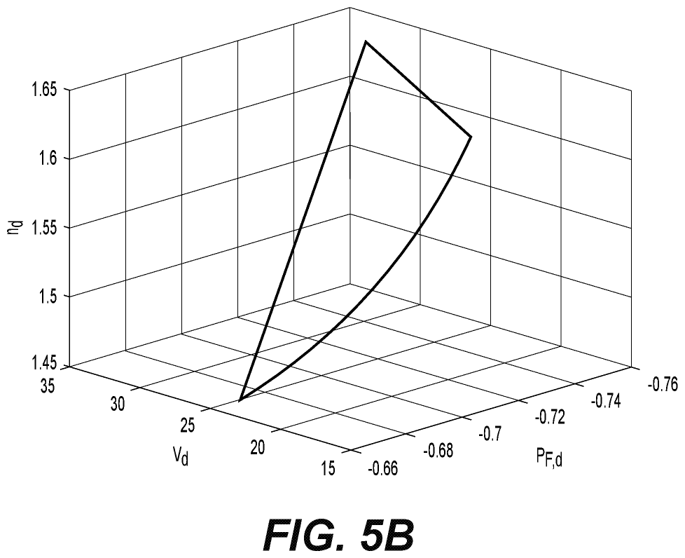

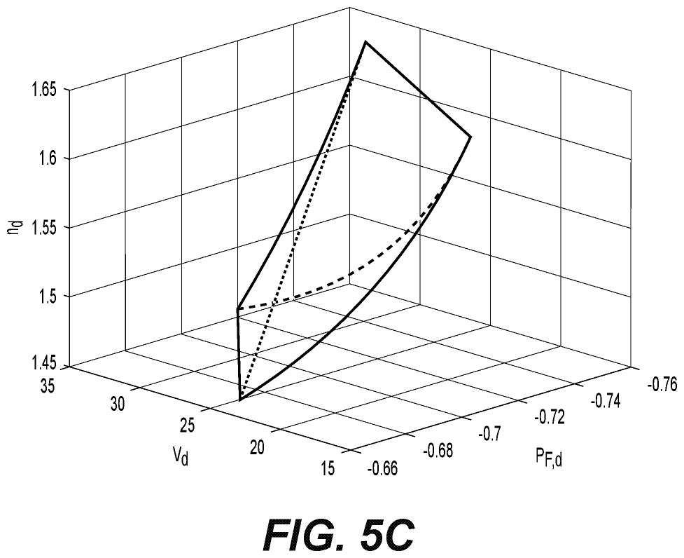

The plots shown in FIG. 5 are examples of a binary, ternary, and quaternary GRIN (based on material information in table 2 below), plotted in n_{d} vs V_{d} vs P_{F,d} space. The black lines span the boundaries of possible index and dispersion values achievable by each GRIN. Note that a homogeneous material forms a point (not shown), a binary GRIN forms a curve, a ternary GRIN forms a surface, and a quaternary GRIN forms a volume in the 3D space.

Using a binary GRIN severely limits the dispersion values a GRIN can achieve, whereas a quaternary GRIN affords the GRIN the ability to freely explore the 3D dispersion space; a ternary GRIN exists somewhere in-between-more room to explore the space, but still ultimately bounded in some dimensions. Therefore, a four material multi-material GRIN allows total freedom to explore the space (i.e., the lens can take any combination of refractive index/Abbe number/partial dispersion values) so long as it is bounded by the volume.

The use of three dimensional mapping of the space enables the optical designer to choose with greater facility the three or more different materials to fabricate a GRIN appropriate for the desired gradient-index profile for the purposes described herein. One of ordinary skill will understand that the choice of materials is constrained by the boundaries of the plotted three-dimensional space, but not otherwise limited for the purposes described herein.

### Multi-Material GRIN Representation

Before beginning a design study, a new refractive index representation needs to be constructed that accurately models the multi-material GRIN and constrains the index profile to realizable mixtures of the materials. Previously, Lippman et al. [David H. Lippman, Robert Chou, Ankur X. Desai, Nicholas S. Kochan, Tianyi Yang, Greg R. Schmidt, Julie L. Bentley, and Duncan T. Moore, “Polychromatic annular folded lenses using freeform gradient-index optics,” Appl. Opt. 61, A1-A9 (2022)] modeled a multi-material GRIN by varying the GRIN coefficients with respect to wavelength. And while this significantly improved their design, it did not guarantee that the GRIN could be made with available materials.

The multi-material representation of GRIN used for the all instances described herein, such as the spectrometer, is a formulation that described the 3D refractive index distribution as a linear composition of N materials. The index is described as follows:

$${n}_{GRIN} ( x , y , z , λ ) = {\sum }_{i = 1}^{N} {γ}_{i} ( x , y , z ) {n}_{i} ( λ ) \qquad ( 3 )$$

where n_{GRIN} is the refractive index of the GRIN at each point spatially and spectrally, γᵢ is the composition ratio of the i^{th} material used in the GRIN, nᵢ is the refractive index of the i^{th} material, and N is the total number of materials in the GRIN. For three materials, this can be rewritten as

$${n}_{GRIN} ( x , y , z , λ ) = {n}_{0} ( λ ) + Δ {n}_{31} ( λ ) = {γ}_{1}^{′} ( x , y , z ) + Δ {n}_{32} ( λ ) {γ}_{2}^{′} ( x , y , z ) \qquad ( 4 )$$

where n₀(λ) is the average index of the three materials,

$$Δ {n}_{3 j} = \frac{( {n}_{3} - {n}_{j} )}{3} ,$$

$$and$$

$${γ}_{j} = \frac{1 - {γ}_{j}^{′}}{3} .$$

For four materials, the 3D refractive index is written as

$$\begin{matrix}{R}_{GRIN} ( x , y , z , λ ) = {n}_{0} ( λ ) + Δ {n}_{41} ( λ ) {γ}_{1}^{′} ( x , y , z ) \\ + Δ {n}_{42} ( λ ) {γ}_{2}^{′} ( x , y , z ) \\ + Δ {n}_{43} ( λ ) {γ}_{3}^{′} ( x , y , z )\end{matrix} \qquad ( 5 )$$

where n₀ is the average of the four material indices,

$$Δ {n}_{4 k} = \frac{( {n}_{4} - {n}_{k} )}{4} ,$$

$$and$$

$${γ}_{k} = \frac{1 - {γ}_{k}^{′}}{4} .$$

γ′ is then defined in the lateral dimension (XY) using the Fringe Zernike polynomials and in the axial dimension (Z) using the Legendre polynomials, identical to Yang et al. [Tianyi Yang, Nick Takaki, Julie Bentley, Greg Schmidt, and Duncan T. Moore, “Efficient representation of freeform gradient-index profiles for non-rotationally symmetric optical design,” Opt. Express 28, 14788-14806 (2020)].

In this setup, the spectral splitting is attained through the use of the y-tilt term. If a dispersive F-GRIN is used, this term will refract the light by differing amounts depending on the wavelength [David H. Lippman and Greg R. Schmidt, “Prescribed irradiance distributions with freeform gradient-index optics,” Opt. Express 28, 29132-29147 (2020)]. This separation of color by the GRIN is perfectly analogous to that achieved by a prism, wherein the tilted surfaces of the prism are replaced by the F-GRIN tilt term.

### Use of Multi-Material GRIN Technology

The methods and systems described herein may be used in conjunction with imaging for any relevant imaging device that may incorporate lens technology including, but not limited to, devices such as: hyperspectral imagers (HSIs), lightguides, waveguides, photonic integrated circuits (PICs), wavelength-division multiplexers (WDMs), and cell phone lenses.

Other potential uses may be in relation to telecommunications or super apochromatic lenses. One of ordinary skill will understand that the four material multi-material gradient-index profiles described in lenses herein may be used in any relevant system where superior correction of chromatic aberrations is desired for the entire optical system. One of ordinary skill will understand that the methods and systems described herein may be used to correct optical aberrations or address color dispersion in a wide variety of contexts and their application is not limited by the listing of particular usages herein.

The present application is further illustrated by the following examples that should not be construed as limiting. The contents of all references, patents, and published patent applications cited throughout this application, as well as the Figures and Tables, are incorporated herein by reference. One of ordinary skill will understand that the uses of the multi-material GRINs described herein are not limited to single axis uses and the application of the devices and methods described herein may occur in lenses for other applications than those explicitly mentioned herein. One of ordinary skill will further understand that the embodiments described herein are not limited to those of a certain mathematical representation. The methods and systems described herein are not limited by the form of a particular mathematical representation; and one of ordinary skill will be able to envision how other mathematical representations can be used to implement the methods and systems described herein.

### EXAMPLES

### Example 1: Achromatization of Gradient-Index Singlets Using Multi-Materials GRINs

In this example, the freeform-GRIN (F-GRIN) representation introduced by Yang et al. is leveraged [Tianyi Yang, Nick Takaki, Julie Bentley, Greg Schmidt, and Duncan T. Moore, “Efficient representation of freeform gradient-index profiles for non-rotationally symmetric optical design,” Opt. Express 28, 14788-14806 (2020)] and extended to include any number of materials. A linear composition model is assumed, which, although not exact, approximately matches the behavior of optical plastics [Mccarthy, Peter W. “Gradient-Index Materials, Design, and Metrology for Broadband Imaging Systems” Thesis (Ph.D.)—University of Rochester. Hajim College of Engineering and Applied Science. The Institute of Optics., 2015; P. McCarthy and D. T. Moore, “Optical design with gradient-index elements constrained to real material properties,” in Imaging and Applied Optics Technical Papers, OSA Technical Digest (2012), paper OTu4D.2.].

The F-GRIN representations were encoded in a dynamic-link library (DLL) as a user-defined GRIN in CODE V. The goal is to optimize an f/2.8, 1° full field-of-view (FFOV) GRIN singlet in the visible, with special attention paid to the chromatic effects of adding additional materials to the GRIN. A Qcon asphere [G. W. Forbes, “Shape specification for axially symmetric optical surfaces,” Opt. Express 15, 5218-5226 (2007)], varying up to 10th order, is used on the front surface to correct higher orders of spherical aberration and isolate the GRIN impact to be solely chromatic in nature. Materials for all the GRIN designs were chosen from a catalog provided by Nanovox LLC.

TABLE 1
Specification table for the singlet design. F-GRIN term notation
is defined by Yang et al. [Tianyi Yang, Nick Takaki, Julie Bentley,
Greg Schmidt, and Duncan T. Moore, “Efficient representation
of freeform gradient-index profiles for non-rotationally symmetric
optical design,” Opt. Express 28, 14788-14806 (2020)].

| Specification | Value |
|---|---|
| Focal length [mm] | 28 |
| FFOV [°] | 1° |
| Wavelengths [nm] | 656.3, 621.9, 587.6, 536.9, 486.1 |
| f/# | 2.8 |
| Element center thickness [mm] | 5 |
| Surface type | Front: Qcon asphere; Back: sphere |
| F-GRIN terms | U₀₄V₀, U₀₉V₀, U₁₆V₀ |

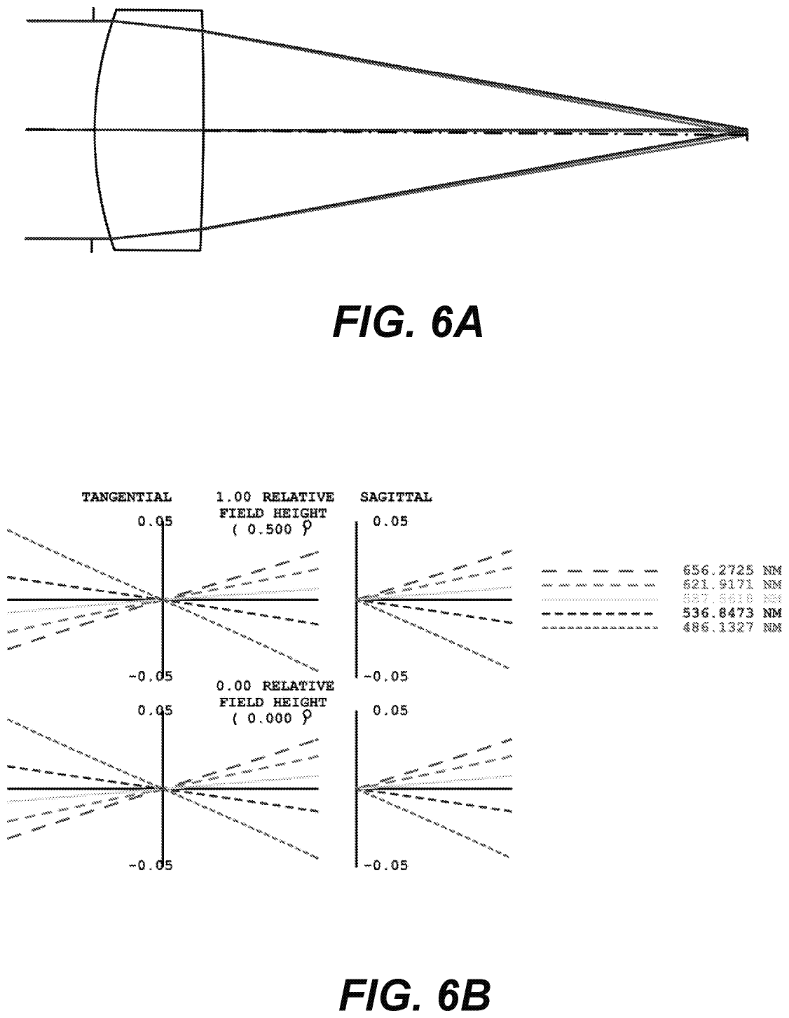

First, a homogeneous NBK7 singlet is shown for comparison in FIG. 6. The transverse ray error plot shows all five wavelengths coming to separate longitudinal focuses. The largest separation is between the two ends of the spectrum, signifying that the design is limited by primary color.

Next, the design process is repeated for a binary GRIN singlet, which uses materials 1 and 3 from table 2 below.

TABLE 2
Material information for the GRIN design study. The
four dispersive materials were chosen to provide
good Abbe number and partial dispersion coverage.

| | n_{d} | V_{d} | P_{F, d} |
|---|---|---|---|
| Material 1 | 1.637 | 17.36 | 0.715 |
| Material 2 | 1.639 | 31.96 | 0.750 |
| Material 3 | 1.457 | 23.99 | 0.666 |
| Material 4 | 1.472 | 32.17 | 0.706 |

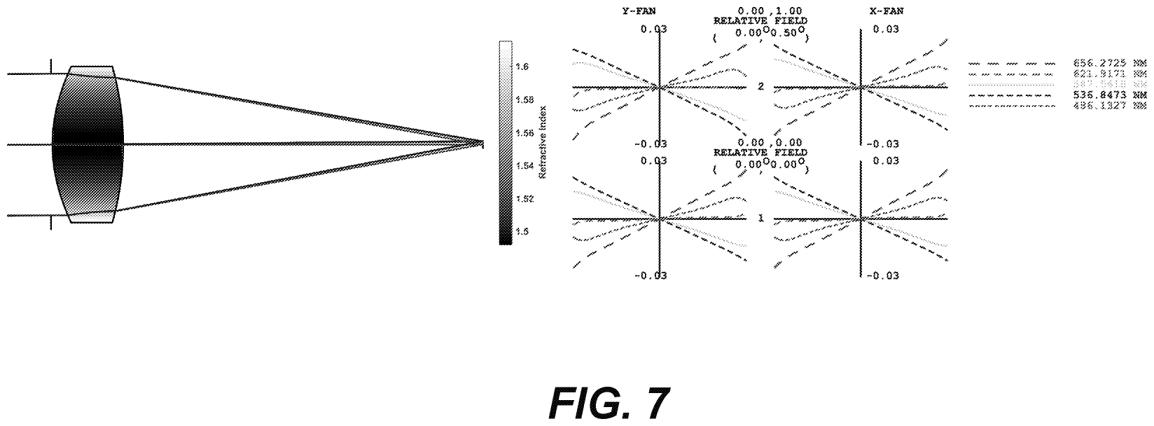

The addition of the binary GRIN significantly improved performance, reducing the spot size and the RMS wavefront performance by a factor of ˜2. The transverse ray error plot in FIG. 7 shows the main reason why: the longest and shortest wavelengths now focus to near the same position, signifying that the primary color has been nearly corrected. Performance is now limited by secondary color, i.e., the two ends of the spectrum do not focus to the same position as the center of the spectrum. It is worth noting that a large amount of optical power is being introduced by the GRIN (large Δn_{d}) to correct the residual chromatic aberrations.

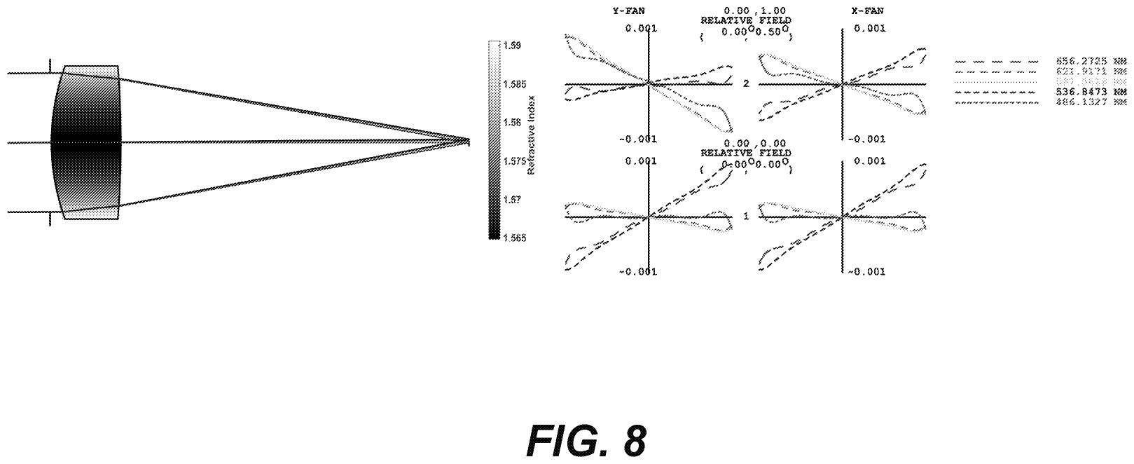

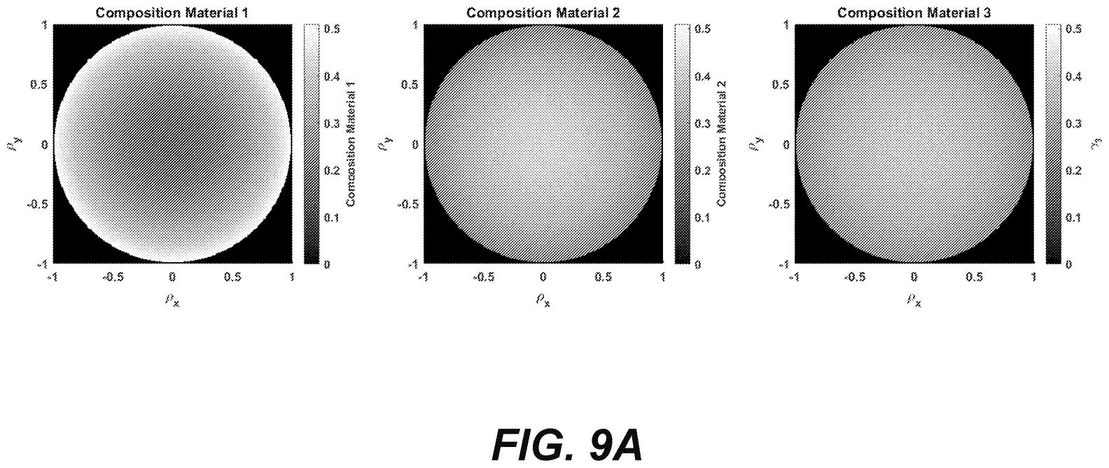

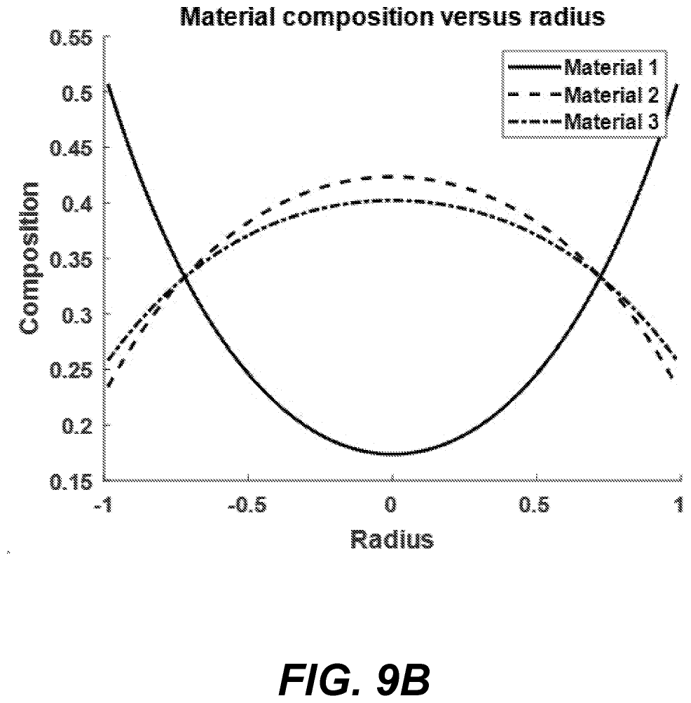

In FIG. 8, the ternary GRIN, which uses materials 1-3 from table 2 above (see also FIG. 9), achieves levels of color correction not afforded by the traditional binary GRIN. The spot size and RMS wavefront performance are both reduced by a factor of ˜25. The transverse ray error plots show the correction of secondary color, as now the five wavelengths come to two separate focuses (where in FIG. 7 they came to three separate focuses). Note that the superior color correcting capabilities of the ternary GRIN were achieved with a Δn_{d} of only 0.026 (compared to the binary value of 0.123).

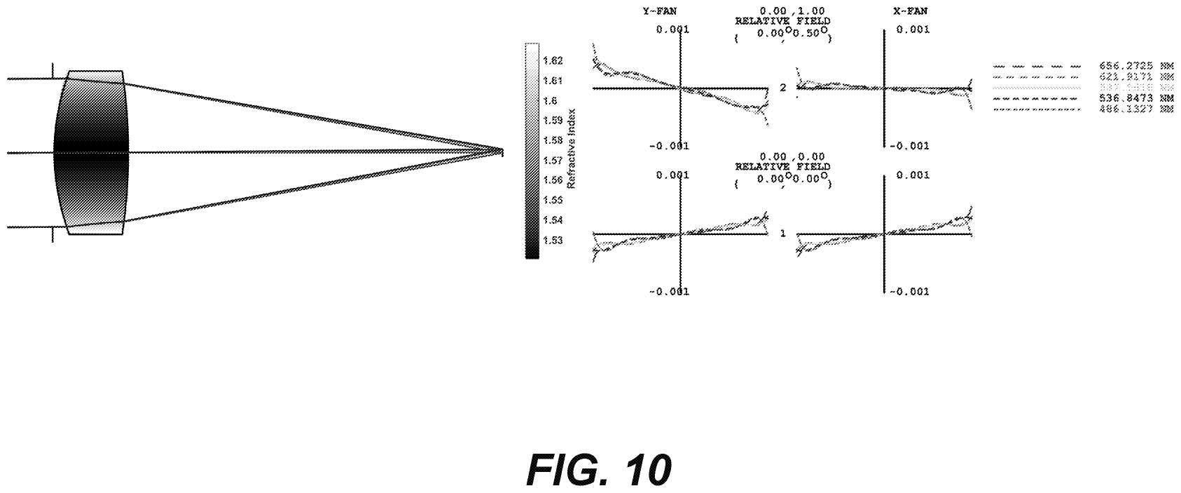

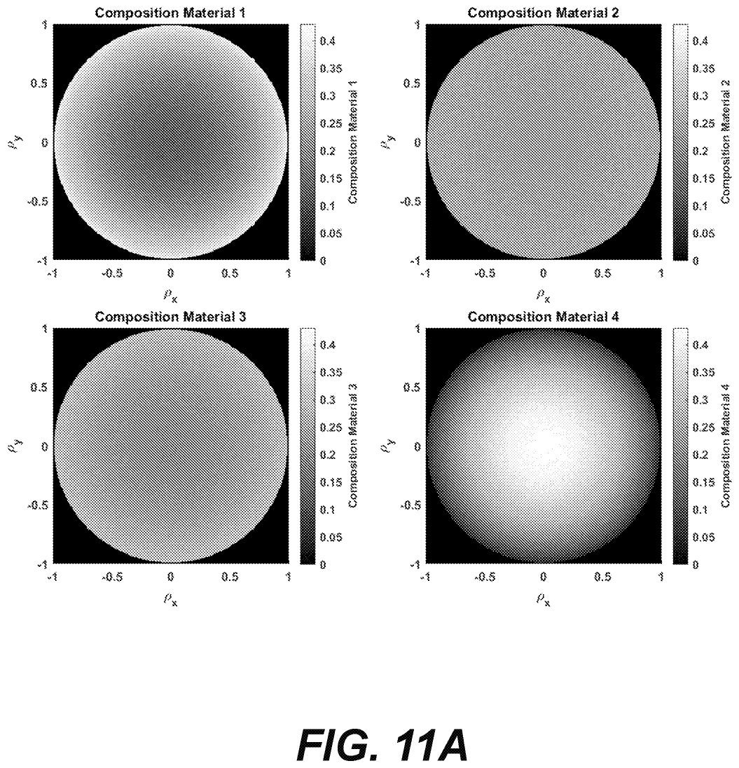

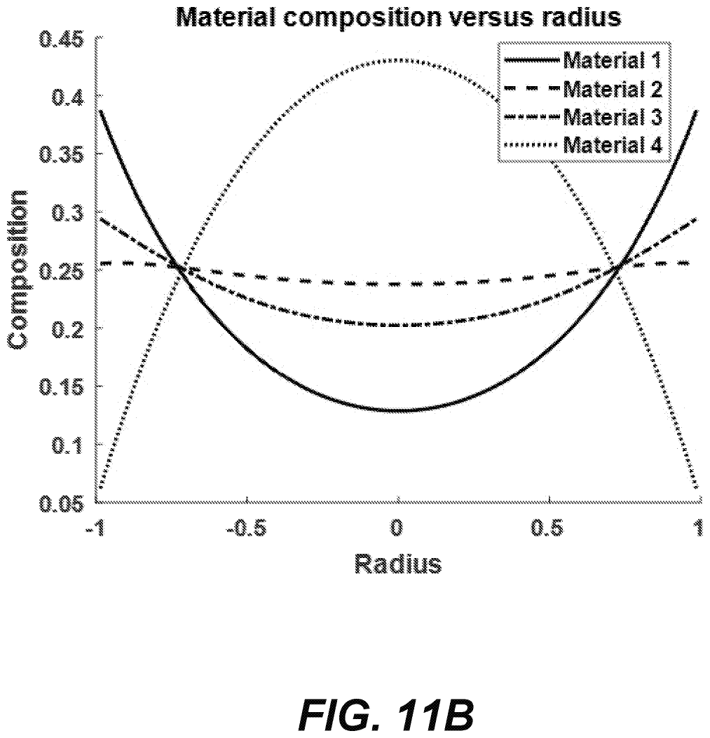

Now, in FIG. 10, the quaternary GRIN, using materials 1-4 from table 2 above (see also FIG. 11A-B), all five wavelengths come to the same longitudinal focus. The chromatic performance has improved to the point that the system as modeled is now limited by monochromatic aberrations (namely, astigmatism and Petzval). When used in a multi-element system, this quaternary GRIN provides the useful design tool of being able to contribute optical power without changing the chromatic aberration balance of the system. This application is the first example of a hyper apochromatic singlet.

### Example 2: Freeform Gradient-Index Spectrometers Using Multi-Material GRINs

This application introduces a new category of spectrometers. A binary, ternary, and quaternary F-GRIN spectrometer are designed and compared. All spectrometers are f/6 and analyzed with an on-axis field-of-view.

In certain embodiments, the spectrometers use line field-of-view (FOVs), which are common in many hyperspectral imagers (HSI), which typically operate in a push broom fashion [V. R. K. Murty, “Theory and Principles of Monochromators, Spectrometers and Spectrographs,” Opt. Eng. 13(1) 130123 (1 Feb. 1974); Yuxuan Liu, Aaron Bauer, Thierry Viard, and Jannick P. Rolland, “Freeform hyperspectral imager design in a CubeSat format,” Opt. Express 29, 35915-35928 (2021)]. One of ordinary skill will understand that the uses of the multi-material GRINs described herein are not limited to on-axis use or line FOVs and the application of the devices and methods described herein may occur in spectrometers of other types than those explicitly mentioned herein.

The wavelength range is currently limited to the visible (486.1 nm-656.3 nm) due to limited material information, although fully characterized materials with high transmission from 400 nm-2.5 μm are currently being investigated. [Conkey, D., “Freeform optics for optical payloads with reduced size and weight.” nasasitebuilder.nasawestprime.com/xrcf/wp-content/uploads/sites/42/2018/02/31-Voxtel-Freeform-Optics-for-Optical-Payloads.pdf].

The wavelength separation, defined at the image plane as the lateral distance between chief rays, is set to 500 μm. This is a modest value compared to most HSIs, but can be increased with a thicker F-GRIN, additional elements, and/or tilted surfaces. Materials for all the F-GRIN designs were chosen from a catalog provided by Nanovox LLC [Campbell, S. D., Brocker, D. E., Werner, D. H., Dupuy, C., Park, S.-K., and Harmon, P., “Three-dimensional gradient-index optics via injketaided additive manufacturing techniques,” in [2015 IEEE International Symposium on Antennas and Propagation & USNC/URSI National Radio Science Meeting], 605-606, IEEE (2015); E. Elliot, C. Dupuy, S. Sang, and N. Nguyen, “Proprietary optical ink,” Nanovox LLC].

Due to the fact that the d-line wavelength is not used, the Abbe number and partial dispersion are redefined according to

$$V = \frac{{n}_{mid} - 1}{{n}_{short} - {n}_{long}} \qquad ( 6 )$$

$$P = \frac{{n}_{short} - {n}_{mid}}{{n}_{short} - {n}_{long}} \qquad ( 7 )$$

where the refractive index subscripts refer to the wavelengths used.

TABLE 3
Specification table for the spectrometer design.
F-GRIN term notation is defined by Yang et al.

| Specification | Value |
|---|---|
| Focal length [mm] | 60 |
| FFOV [°] | On-axis |
| Wavelengths [nm] | 656.3, 613.7, 571.2, 528.7, 486.1 |
| Wavelength separation [μm] | 500 |
| f/# | 6 |
| Element center thickness [mm] | 10 |
| F-GRIN terms | U₀₃V₀, U₀₄V₀, U₀₉V₀, U₁₆V₀ |

### Binary GRIN

First, a traditional GRIN is studied, which uses a GRIN of two materials (table 4 below).

TABLE 4
Material information for the binary F-GRIN spectrometer.

| | n_{mid} | V | P | P_{GRIN} |
|---|---|---|---|---|
| Material 1 | 1.514 | 41.3 | 0.574 | 0.521 |
| Material 2 | 1.426 | 57.2 | 0.610 | |

This pair was chosen for its large Δn and for its P_{GRIN}, which is defined as

$${P}_{GRIN} = \frac{Δ {n}_{short} - Δ {n}_{mid}}{Δ {n}_{short} - Δ {n}_{long}} \qquad ( 8 )$$

The partial dispersion is the departure from a linear relation between wavelength and refractive index curve, which relates to the linearity of the spectrometer. Linear spectrometers are desirable for uniform spectral sampling. For linear dispersion, the dispersion curve should be a straight line between the linearly spaced wavelengths, which gives us a P_{GRIN} value of 0.5. It is unrealistic to find a pair of materials with exactly this value, so the closest in the catalog was chosen.

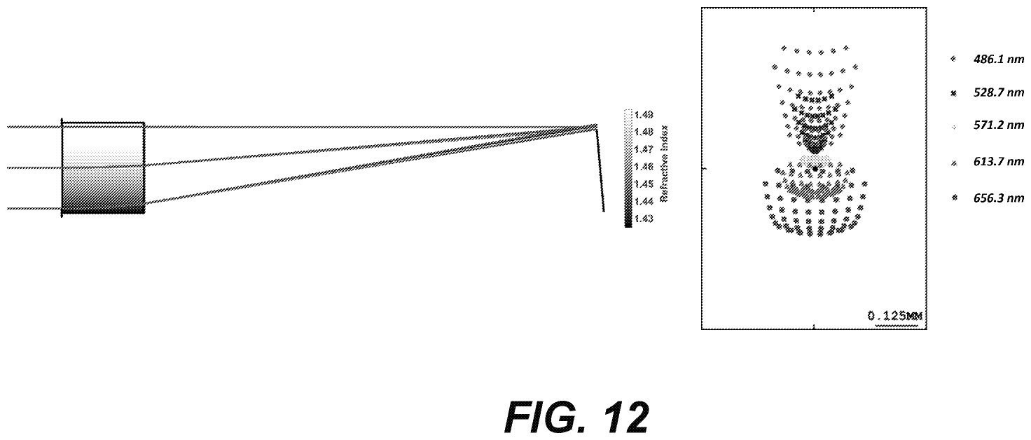

As can be seen in FIG. 12, the system performs quite poorly, even with a small amount of image plane tilt (<5°) added to improve performance. The spots almost completely overlap, and what's more, the wavelength separation achieved is only 215 μm (limited by the lower refractive index of material 2).

This system is unusable as a spectrometer because it fails to achromatically focus the light. This is because the system did not use a highly dispersive F-GRIN in order to separate the colors. The tilt term is highly wavelength dependent (by design), so the power term must also be wavelength dependent; the dispersion of a binary GRIN is completely determined by the change in refractive index.

It is impossible with only two materials to have a wavelength dependent tilt and a wavelength independent power (necessary for achromatic focusing).

The introduction of a third and fourth material allows separate tuning of the spatial refractive index change and the dispersion of the F-GRIN. Meaning, it is possible to have a wavelength dependent tilt and wavelength independent power.

### Ternary GRIN

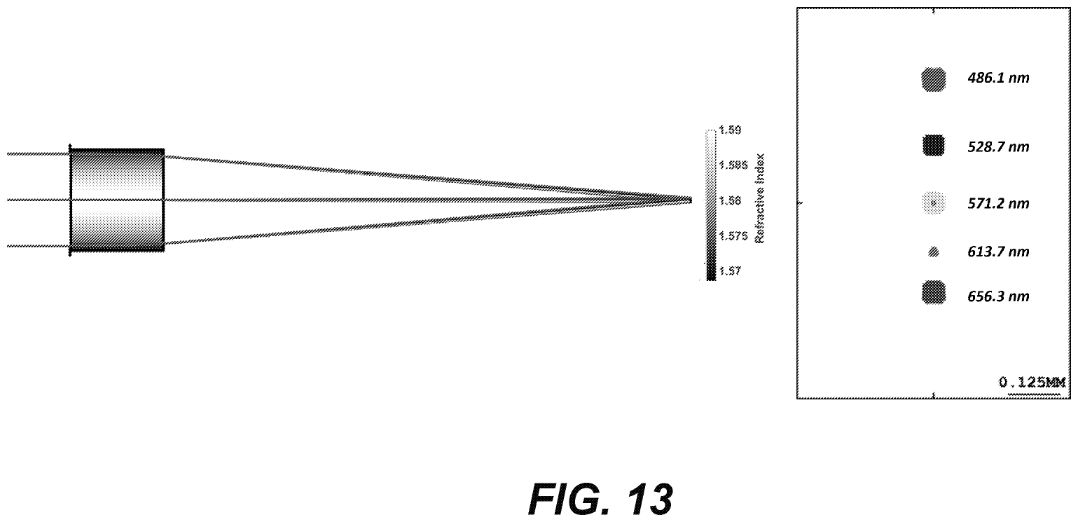

The ternary GRIN spectrometer, which uses materials 1-3 from table 5 below, can be seen in FIG. 13.

TABLE 5
Material information for the ternary (materials 1-3)
and quaternary (materials 1-4) F-GRIN spectrometers.
These four dispersive materials were chosen to provide
good Abbe number and partial dispersion coverage.

| | n_{mid} | V | P |
|---|---|---|---|
| Material 1 | 1.640 | 17.44 | 0.629 |
| Material 2 | 1.641 | 32.04 | 0.670 |
| Material 3 | 1.457 | 24.08 | 0.574 |
| Material 4 | 1.473 | 32.26 | 0.618 |

The individual spots in FIG. 13 are now separated and are being focused (although there are some residual aberrations). The wavelengths chosen for this application are linearly separated in wavelength, so ideally, the spots would be linearly separated as well. The average linearity error for this design, calculated as the difference between real and ideal chief ray locations, is 19.6 μm. The errors in linearity are largely dictated by the partial dispersion of the F-GRIN.

### Quaternary GRIN Example 1

The introduction of a fourth material allows additional control over the F-GRIN dispersion, which improves both the spectrometer performance and linearity.

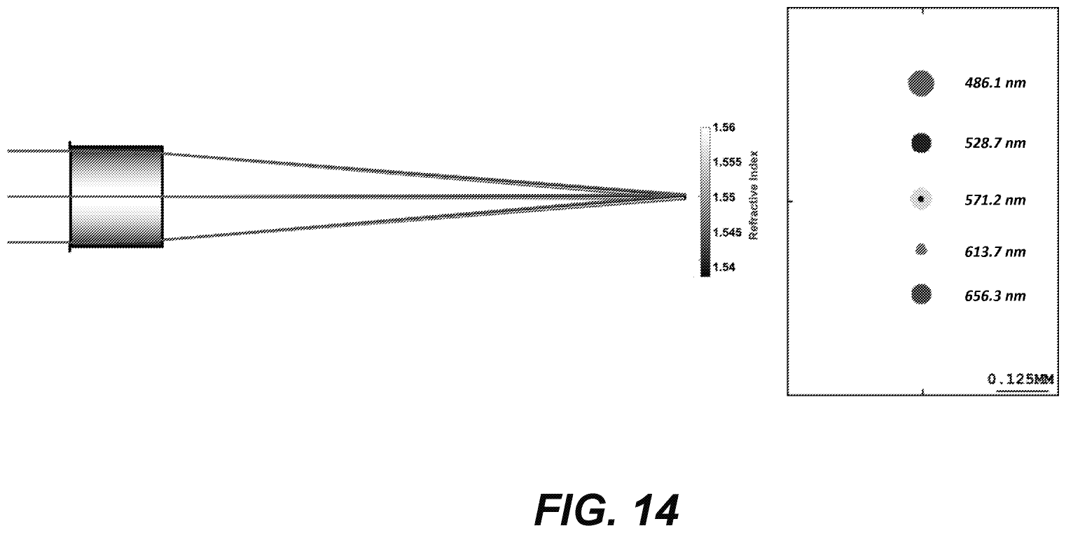

The quaternary F-GRIN spectrometer, which uses materials 1-4 from table 5 above, is shown in FIG. 14. Note the improvement in both average wavefront performance and linearity error.

### Quaternary GRIN Example 2

To continue exploring the quaternary F-GRIN spectrometer design space, a second group of materials was chosen.

TABLE 6
Material information for a second
quaternary F-GRIN spectrometer.

| | n_{mid} | V | P |
|---|---|---|---|
| Material 1 | 1.796 | 18.58 | 0.633 |
| Material 2 | 1.625 | 46.65 | 0.574 |
| Material 3 | 1.457 | 24.08 | 0.574 |
| Material 4 | 1.410 | 67.24 | 0.610 |

The four materials in table 6 above were selected to provide a larger range of refractive index and Abbe numbers compared to table 5, but sacrificed the large partial dispersion coverage.

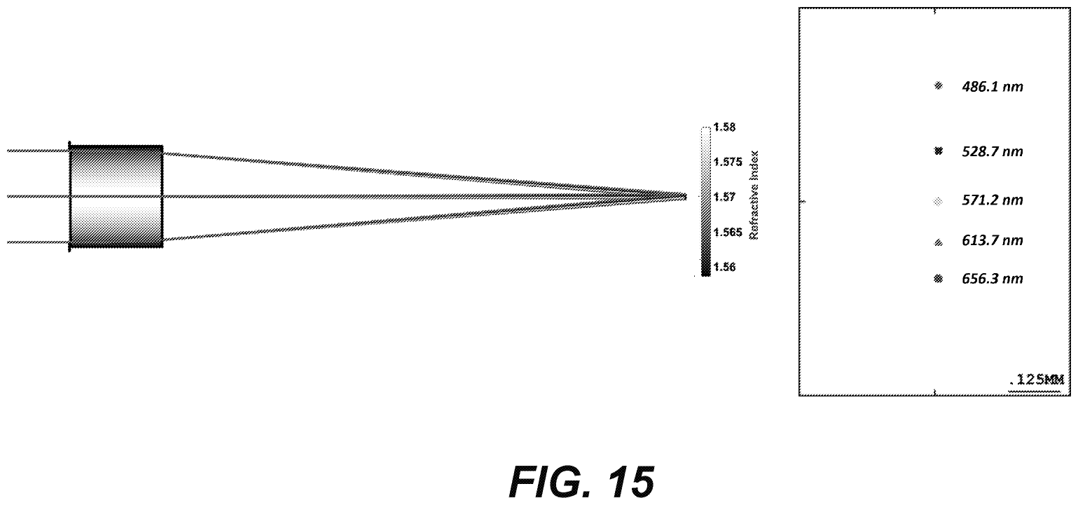

Such a choice, as seen in FIG. 15, greatly improved the wavefront performance of the system, as it is now well below the diffraction limit. But this only occurred at the expense of doubling the linearity error. A larger range of refractive index and Abbe numbers improves the performance, while a smaller range of partial dispersion values degrades the linearity. A preferred four material system would have as large a range of refractive index, Abbe number, and partial dispersion as possible.

### Quaternary GRIN Example 3

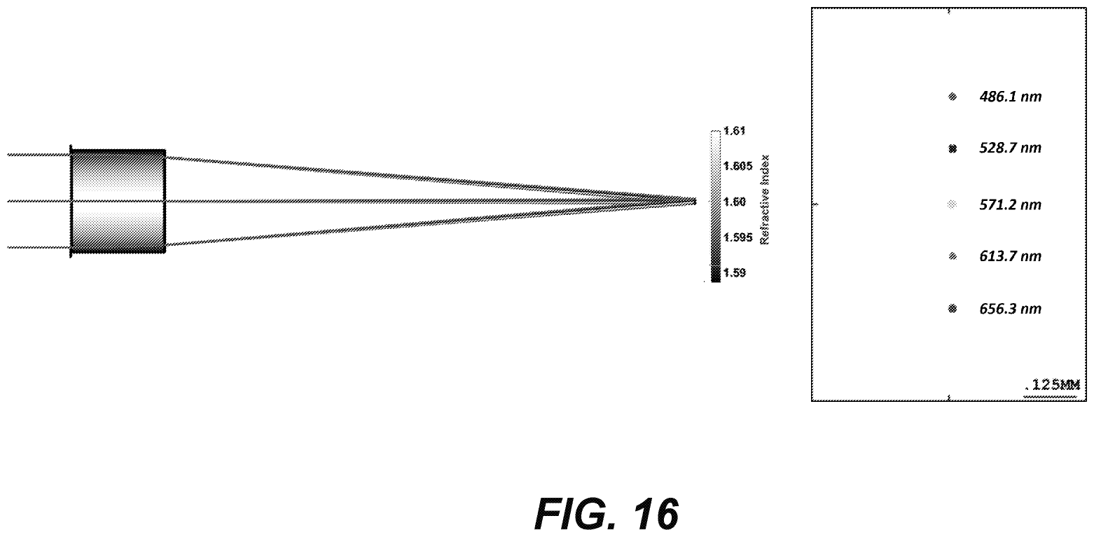

For the designs shown in FIGS. 12-15, γᵢ from eq. 3 was allowed to vary while nᵢ was held constant. The final design in FIG. 16 allows both sets of terms to vary while constraining the values of nᵢ towards physically realizable options. The goal of varying the refractive indices is to find an optimal solution, but, in this particular embodiment, the dispersion of these base materials must be within ranges expected for the visible band. Based on the provided Nanovox catalog of GRIN base materials, the refractive index is constrained as 1.4≤n_{mid}≤1.8, the Abbe number as 17≤V≤70, and the partial dispersion as 0.57≤P≤0.67. One of ordinary skill will understand that the ranges of values given herein are not limiting upon the application of the methods, systems or devices described herein, and may be outside the visible band (e.g., in certain embodiments, the refractive index may be between 2 to 4).

The optimized material information in table 7 combines the best attributes of the materials from tables 5 and 6: a large coverage of Abbe number and partial dispersion. This design outperforms the linearity of the design in FIG. 14 and matches the RMS wavefront performance of the design in FIG. 15.

TABLE 7
Optimized material information for an
ideal quaternary F-GRIN spectrometer.

| | n_{mid} | V | P |
|---|---|---|---|
| Material 1 | 1.672 | 22.86 | 0.588 |
| Material 2 | 1.646 | 53.45 | 0.650 |
| Material 3 | 1.503 | 23.87 | 0.589 |
| Material 4 | 1.564 | 39.32 | 0.655 |

A spectrometer with a solid dispersive element made using these four materials can be realized with desirable refractive index, Abbe number and partial dispersion properties thanks to rapid advances in material research, such as 3D printing technology, etc. The obvious performance benefits seen in FIG. 16 show the potential of new optical polymers and glasses that have the requisite characteristics.

One of ordinary skill will understand that although the examples herein use solid elements with planar surfaces, this is not a limitation of the devices or methods described herein which may also be applied in relation to solid elements with spherical surfaces, aspherical surfaces, curved surfaces of different angles, tilted surfaces of different angles, freeform surfaces of different shapes, a diffractive surface, mirrored surfaces and partially mirrored surface, etc, without limitation.

While various embodiments have been described above, it should be understood that such disclosures have been presented by way of example only and are not limiting. Thus, the breadth and scope of the subject compositions and methods should not be limited by any of the above-described exemplary embodiments but should be defined only in accordance with the following claims and their equivalents.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the components and steps in any sequence which is effective to meet the objectives there intended, unless the context specifically indicates the contrary.

1. An imaging apparatus comprising:
an optical system comprising at least one dispersion controlling element, wherein electromagnetic radiation is passed through said at least one dispersion controlling element, wherein said electromagnetic radiation comprises optical wavelengths;
said at least one dispersion controlling element, wherein said dispersion controlling element is a multi-material gradient-index (GRIN) element, wherein the multi-material gradient-index element comprises three or more materials;
said optical system also being capable of imaging said electromagnetic radiation onto at least one detecting element;
said at least one detecting element being capable of detecting electromagnetic radiation passed through said dispersion controlling element.

2. The imaging apparatus of claim 1, wherein said electromagnetic radiation is emanating from a slit element.

3. The imaging apparatus of claim 1, wherein said multi-material gradient-index element is made from three different materials.

4. The imaging apparatus of claim 1, wherein said multi-material GRIN gradient-index element is made from four different materials.

5. The imaging apparatus of claim 1, wherein said optical wavelengths are in the range that are visible to the human eye.

6. The imaging apparatus of claim 1, wherein said optical wavelengths are in the range 10 nm to 1000 microns.

7. The imaging apparatus of claim 1, wherein said multi-material gradient-index element is a freeform gradient-index element.

8. The imaging apparatus of claim 1, wherein said dispersion controlling element has a front-facing surface and a rear-facing surface, wherein said front-facing surface receives optical wavelengths before said rear-facing surface, and wherein said front-facing surface comprises one or more surface types selected from the group of surface types consisting of a planar surface, a spherical surface, an aspherical surface, a curved surface, a freeform surface, a tilted surface, a diffractive surface, mirrored surface and partially mirrored surface; and wherein said rear-facing surface comprises one or more surface types selected from the group of surface types consisting of a planar surface, a spherical surface, an aspherical surface, a curved surface, a freeform surface, a tilted surface, a diffractive surface, mirrored surface and partially mirrored surface.

9. The imaging apparatus of claim 1, wherein the apparatus has a field-of-view that is zero-dimension (on-axis), or optionally one dimension (line), or optionally two dimension.

10. The imaging apparatus of claim 1, wherein the apparatus is a hyperspectral imager.

11. The imaging apparatus of claim 1, further comprising a photonic integrated circuit.

12. A method of using the imaging apparatus of claim 1, comprising the steps of:
obtaining an image for use in one or more fields selected from the group consisting of agriculture, biotechnology, food analysis, environmental monitoring, medical imaging, artwork authentication, telecommunications, photonics, remote sensing and machine vision.

13. A hyperspectral imaging method, comprising the steps of:
fabricating in a composition together three or more different materials to form a dispersive element, wherein said formed dispersive element comprises a multi-material gradient-index profile;
passing electromagnetic radiation through said dispersive element, wherein said electromagnetic radiation comprises optical wavelengths, wherein said passage through said dispersive element spectrally splits said optical wavelengths;
detecting dispersed electromagnetic radiation from said dispersive element to form an image.

14. The hyperspectral imaging method of claim 13, comprising the steps of: fabricating in a composition together four or more different materials to form a dispersive element, wherein said formed dispersive element comprises a multi-material gradient-index profile.

15. The hyperspectral imaging method of claim 13, wherein said optical wavelengths are in the range that are visible to the human eye.

16. The hyperspectral imaging method of claim 13, wherein said optical wavelengths are in the range 10 nm to 1000 microns.

17. The hyperspectral imaging method of claim 13, wherein said dispersive element has a front-facing surface and a rear-facing surface, wherein said front-facing surface receives optical wavelengths before said rear-facing surface, and wherein said front-facing surface comprises one or more surface types selected from the group of surface types consisting of a planar surface, a spherical surface, an aspherical surface, a curved surface, a freeform surface, a tilted surface, a diffractive surface, mirrored surface and partially mirrored surface; and wherein said rear-facing surface comprises one or more surface types selected from the group of surface types consisting of a planar surface, a spherical surface, an aspherical surface, a curved surface, a freeform surface, a tilted surface, a diffractive surface, mirrored surface and partially mirrored surface.

18. The hyperspectral imaging method of claim 13, further comprising the step of embedding said dispersive element within a photonic integrated circuit.

19. A multi-material gradient-index lens, comprising:
four or more different materials,
wherein said lens comprises a multi-material gradient-index profile.

20. The multi-material gradient-index lens of claim 19, wherein said lens has a front-facing surface and a rear-facing surface, wherein said front-facing surface receives optical wavelengths before said rear-facing surface, and wherein said front-facing surface comprises one or more surface types selected from the group of surface types consisting of a planar surface, a spherical surface, an aspherical surface, a curved surface, a freeform surface, a tilted surface, a diffractive surface, mirrored surface and partially mirrored surface; and wherein said rear-facing surface comprises one or more surface types selected from the group of surface types consisting of a planar surface, a spherical surface, an aspherical surface, a curved surface, a freeform surface, a tilted surface, a diffractive surface, mirrored surfaces and partially mirrored surface.

21-43. (canceled)
